(19) United States
(12) Patent Application Publication
(10) Pub. No.: US 2023/0411776 A1
(43) Pub. Date: Dec. 21, 2023

(54) TRACTION BATTERY FOR A VEHICLE

(71) Applicant: Dr. Ing. h.c. F. Porsche Aktiengesellschaft, Stuttgart (DE)

(72) Inventors: Philipp KELLNER, Renningen-Malmsheim (DE); Christopher VOLKMER, Niefern-Oeschelbronn (DE); Immanuel VOGEL, Steinheim (DE); Marco AUGUSTDOERFER, Leonberg (DE); Sascha MOSTOFI, Stuttgart (DE)

(21) Appl. No.: 18/318,745

(22) Filed: May 17, 2023

(30) Foreign Application Priority Data
May 20, 2022 (DE) 102022112727.3

(51) Int. Cl. H01M 50/342; H01M 50/211; H01M 50/289; H01M 50/271; B60L 50/64

(52) U.S. Cl. CPC H01M 50/3425; H01M 50/211; H01M 2220/20; H01M 50/271; B60L 50/64; H01M 50/289

(57) ABSTRACT

A traction battery of an electrically or semi-electrically driven vehicle includes one or more cooperating battery modules, in which a respective plurality of chambers are provided for receiving one or more cell stacks from a respective plurality of battery cells. The battery module is configured as a hollow profile, which includes the respective plurality of chambers separated from one another by intermediate walls and running parallel in a longitudinal direction of the hollow profile, into which chambers the cell stacks can be inserted. The hollow profile is sealed at both ends with a respective lid spanning end-side opening cross-sections of all chambers. End sections of the intermediate walls reaching to the opening cross-section are sealed with a separate sealing component against an inside of the lid.

### CROSS REFERENCE TO RELATED APPLICATIONS

This application claims benefit to German Patent Application No. DE 10 2022 112 727.3, filed on May 20, 2022, which is hereby incorporated by reference herein.

### FIELD

The present invention relates to a traction battery for an electrically or semi-electrically driven vehicle, a battery system and a vehicle having such a traction battery.

### BACKGROUND

Traction or propulsion batteries of electrically driven vehicles often consist of a stable battery housing and a plurality of battery modules, which are either arranged in the housing or themselves form the housing. The battery modules are electrically interconnected.

The term and subject-matter “battery module” is often delineated differently in the prior art compared to the drive battery or the power storage or accumulator as a whole, but always includes a combination or a number of interconnected individual battery cells. In addition, a definition is used here in such a way that a traction or drive battery is constructed from battery modules, wherein each battery module forms a housing with chambers in which individual battery cells or cell stacks are arranged. The battery modules protect the battery cells or cell stacks not only against mechanical stresses, especially in case of an accident, but also against environmental factors and should be water-tight and gas-tight and also fire-safe, which is particularly important.

The propulsion or traction batteries of electrically driven vehicles store large amounts of energy due to the plurality of individual battery cells arranged in parallel or serial circuits. In electrochemical energy storage, electrons are stored by the charging current in the individual battery cells by means of a chemical reaction and delivered to electrons during decharging by an inverted chemical reaction. The reaction partners are usually separated from one another by a layer that is permeable only by electrons and ions, so that they are not in direct contact with one another. Modern systems contain as the single cells so-called pouch cells, in which the electrochemically acting elements of a cell, laminar electrodes and electrolytes, are welded in the form of a pouch or cushion between films. Such pouch cells in particular are generally sensitive to mechanical damage and therefore must be protected by stable housings.

The reaction partners of the battery cells, when in direct contact with one another, with the ambient oxygen, with water or other substances in a strong exothermic reaction, can generate heat that is sufficient for the battery cell or constituents to ignite.

In the case of such a thermal event, i.e., an overheating of cells, a large amount of hot gas is produced, which must be conducted out of the cells and from the battery system. Moreover, it is decisive that the gas comes into contact with as little as possible with surrounding battery cells or with other chambers with battery cells in order to prevent, or in any case delay, the ignition of further cells. If, in the case of a thermal event, gas flows from one chamber with cell stacks into another chamber with cell stacks in the case of high-performance traction batteries, this can also lead to inflammation of the cells or cell stacks in the other chamber.

In order to prevent this, fire-resistant materials or partitions are often provided between the individual compartments with cell stacks. Regulations for protecting occupants of electric and hybrid vehicles stipulate that the propagation of fires in a battery module housing or battery system housing must be localized and the transition to adjacent cell stacks must be prevented or at least delayed.

For this purpose, DE 10 2016 013 847 A1 discloses a battery housing for a battery of a motor vehicle, wherein the housing consists of a plurality of housing parts that form chambers that are provided with apertures for passing connecting lines. The housing parts are bolted to gaskets and a separate sealing surface support in order to seal the chambers against one another.

### SUMMARY

In an embodiment, the present disclosure provides a traction battery of an electrically or semi-electrically driven vehicle includes one or more cooperating battery modules, in which a respective plurality of chambers are provided for receiving one or more cell stacks from a respective plurality of battery cells. The battery module is configured as a hollow profile, which comprises the respective plurality of chambers separated from one another by intermediate walls and running parallel in a longitudinal direction of the hollow profile, into which chambers the cell stacks can be inserted. The hollow profile is sealed at both ends with a respective lid spanning end-side opening cross-sections of all chambers. End sections of the intermediate walls reaching to the opening cross-section are sealed with a separate sealing component against an inside of the lid.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates in the form of a perspective sketch a configuration of a battery module;

FIG. 2 illustrates an end section of a battery module according to FIG. 1;

FIG. 3 illustrates a sectional view of a battery module according to FIG. 1; and

FIG. 4 illustrates a sketch of a battery from a plurality of battery modules arranged one behind the other in a vehicle longitudinal direction.

### DETAILED DESCRIPTION

In an embodiment, the present invention provides an easily manufactured traction battery, whose battery modules are configured so as to prevent or delay an ignition of cell stacks or single cells in adjacent chambers to the extent possible.

In an embodiment, the present invention provides a battery system as well as an electrically or semi-electrically driven vehicle having a traction battery.

In the traction battery according to an embodiment of the invention, the battery modules are configured as hollow profiles, each comprising a respective plurality of chambers separated from one another by intermediate walls and extending parallel in the longitudinal direction of the hollow profile, in which the cell stacks can be inserted. The hollow profiles are sealed at both ends with a lid spanning the end-side or front-side opening cross-sections of all chambers, respectively, and the end sections of the intermediate walls reaching up to the opening cross-section are sealed with a separate sealing component towards the inside of the lid.

By adjusting such a separate sealing component to the sealing of the gap between the separation walls and the lid, a secure sealing of the chambers against one another and thus a secure separation of the battery cells or cell stacks in the respective chambers is achieved. This prevents the propagation of fire between cell stacks of adjacent chambers, so-called propagation. This significantly improves vehicle safety.

One advantageous aspect of an embodiment of the invention is that the end-side cavities existing in the chambers of the hollow profile between the lid and cell stacks are gas-tightly sealed against one another by the sealing component and outwardly by a further seal between the lid and outer chamber walls. With such a configuration, the sealing properties of the sealing component on the one hand and the circumferential seal against the outer chamber walls on the other hand can be adapted specifically to the respective requirements. Thus, the sealing component can be made of a different material than the circumferential seals, and in particular, can be arranged such that a compression of the sealing component between the lid and the partition prevents an overflow of gas into the adjacent chamber.

According to a further aspect of the invention, the hollow profiles are configured as extrusion profiles, preferably as severed single lengths of a multi-length extrusion profile. Extrusion profiles can be easily manufactured and can be configured as desired in terms of their cross-section.

A further embodiment of the invention is that the chambers separated by intermediate walls and running parallel in the longitudinal direction of the hollow profiles have identical cross-sections. This also provides for the possibility of using the same profiles or cross-sections for the cell stacks in all chambers.

According to a further aspect of the invention, the lid spanning the chambers comprises at least one degassing opening or one degassing element for each of the chambers separated by intermediate walls and running parallel in the longitudinal direction of the hollow profile. With such a degassing opening or degassing element, it is achieved that, in the event of a gas formation, the gas is discharged from the end-side cavities of the chambers in a manner provided that is as harmless as possible, in particular in a further configuration of the traction battery, in which the degassing opening or degassing element opens upon reaching a specified pressure in the end-side cavity.

In the event that gaps are formed on the seals due to changes in temperature or expansions, it is provided according to a further embodiment of the invention that the flow region releasable for degassing by the degassing opening or the degassing element is larger than a gap cross-section remaining for the sealing component between the end sections of the intermediate walls and the inner side of the lid.

According to a further aspect of the invention, the sealing component is formed from an elastomeric material, preferably from rubber or from a silicone plastic. With such a configuration, on the one hand, a high elasticity of the seals and, on the other hand, a high temperature resistance during heating are provided.

A traction battery having battery modules configured according to an embodiment of the present invention is particularly suitable for a battery system in which a plurality of individually sealed and spaced apart battery modules is provided. Such a battery system can be particularly well adapted to the cavities or installation situations present in a vehicle.

A configuration of an electrically or semi-electrically driven vehicle with a traction battery according to an embodiment of the invention consists in the fact that a plurality of battery modules, which are positioned transverse to the vehicle longitudinal direction with their long axis, are arranged one behind the other in the vehicle longitudinal direction.

Such an arrangement, in particular when the length of the battery modules is configured so that the respective lids covering the chambers reach into the region of the body rocker panels, results in an extremely good accessibility of the individual elements of the traction battery without having to sacrifice safety. The traction battery, or the individual battery modules, would then be accessible from the vehicle exterior and bottom and could, for example, be easily repaired or equipped with new cell stacks. Replacing the battery modules is also easy. In such a configuration in which the modules extend across the width of the vehicle, a particularly dense packing of the battery modules, and thus a traction battery that takes up little space, also results.

In the following, the invention is described with reference to the exemplary embodiments shown in the figures of the drawings.

In the figures, the same or similar elements can be referenced by the same reference numerals.

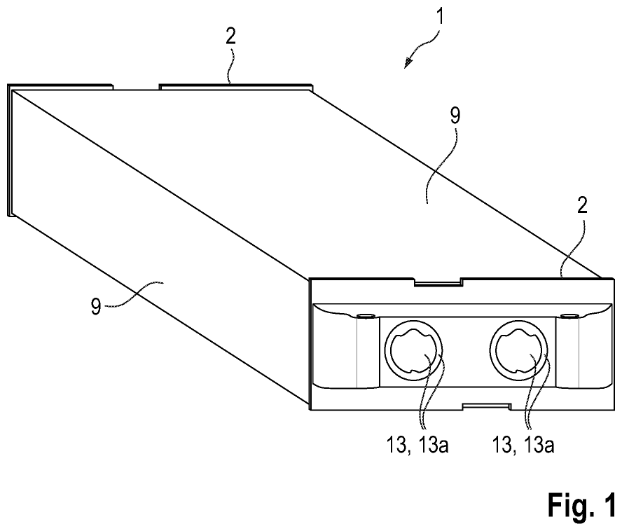

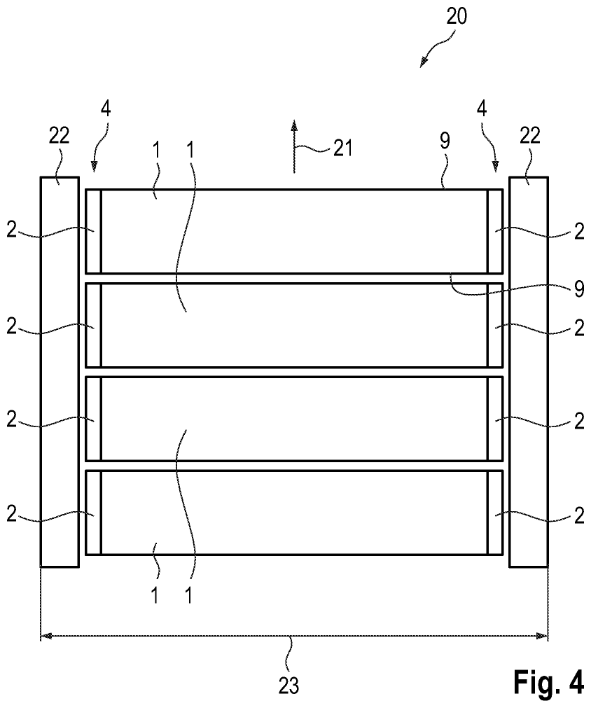

FIGS. 1 to 4 are to be viewed together in order to be able to best discern the configuration of the traction battery according to an embodiment of the invention with its battery modules. FIG. 1 shows in the form of a perspective sketch the principle configuration of a battery module 1 with its two single-sided lids 2 and its outer walls 9. A plurality of such battery modules 1 forms a traction battery 20 in an electrically or semi-electrically driven vehicle. Such a traction battery 20 is shown in principle in FIG. 4.

As outlined in FIG. 4, the battery 20 is constructed from a plurality of cooperating battery modules 1, which are positioned transverse to the vehicle longitudinal direction 21 with their long axis, wherein the battery modules are arranged one behind the other in the vehicle longitudinal direction 21. The length of the battery modules 1 is respectively configured so as to extend approximately beyond the vehicle width 23 and so that the lid 2, which closes the chambers 3 on both sides of the battery modules, extends into the region of the body rocker panels 22.

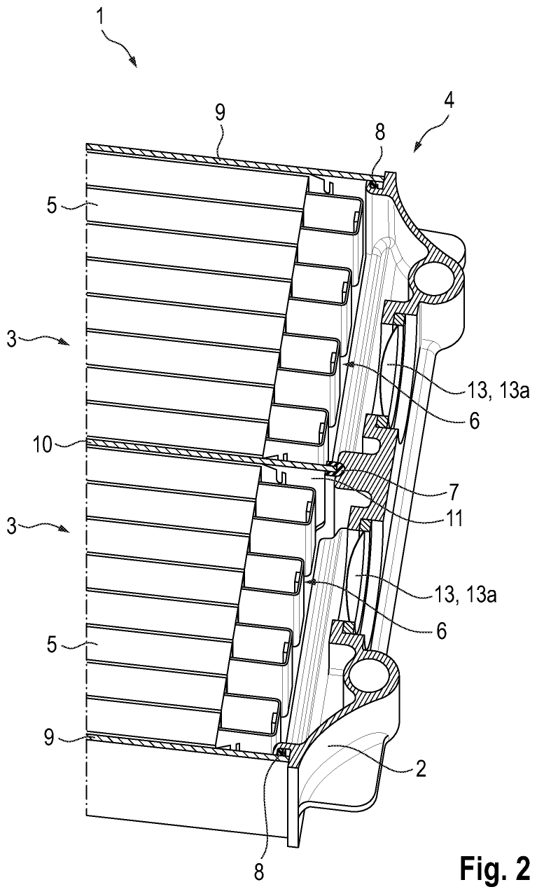

FIG. 2 also shows, in principle, an end section 4 of a battery module 1, the top of which is cut off in order to provide a view of the interior of the battery module. The arrangement of the cell stack 5 located in the chambers 3 of the battery module 1 configured as a hollow profile can be seen there. The formation of the lids 2 and the end-side cavities 6 can also be seen. A further embodiment of the sealing component 7 and the additional seals 8 provided outwardly between the lid 2 and the outer chamber walls 9, i.e., the seals 8 between the lid and the walls of the battery module, is shown.

The battery module 1 is configured here as a hollow profile with two chambers 3, which are separated by an intermediate wall 10 and extend parallel next to one another in the longitudinal direction of the hollow profile. Cell stacks 5 are inserted in the chambers 3. The hollow profile or the battery module 1 is sealed at both ends with a lid 2 spanning the end-side opening cross-sections of the battery module or the chambers 3, respectively. The end sections 11 of the intermediate walls 10 reaching to the opening cross-section are sealed with a separate sealing component 7 against the inside of the lid 2.

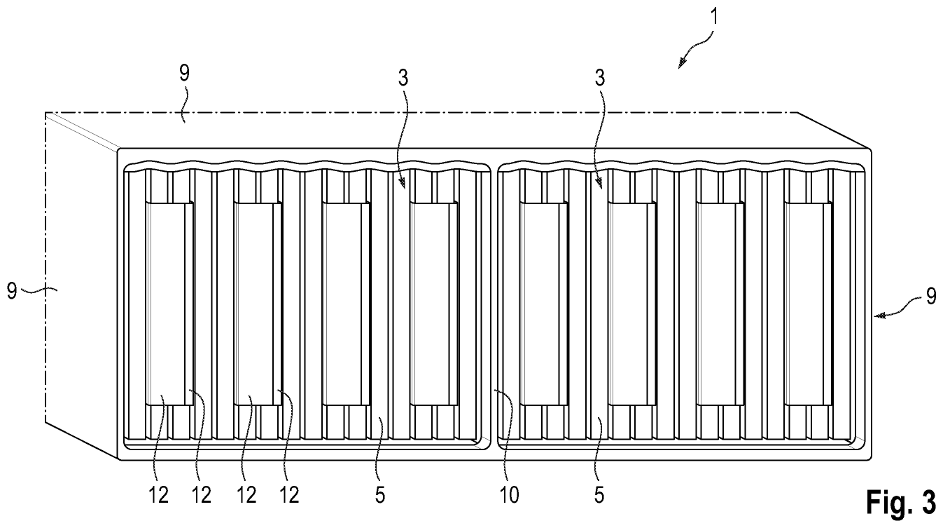

As can be best seen in the sectional view in FIG. 3, the hollow profile or battery module 1 consists of a rectangular hollow profile with two chambers 3 lying parallel next to one another and separated from the other by a right-angled partition 10. The hollow profile is an extruded profile, which was originally produced as a multiple length and then divided into individual lengths that substantially correspond to the length of the battery module, taking into account the reworking required and any attachments mounted thereon. FIG. 3 also shows the contact flags 12 connecting the individual battery cells of the cell stacks 5 together.

In the consideration of FIGS. 1, 2 and 3 together, it can be seen that the end-side cavities 6 of the chambers 3 of the battery module 1 existing between the lid 2 and cell stacks 5 are gas-tightly sealed against one another by the sealing component 7 and outwardly by a circumferential seal 8 between the lid 2 and the outer chamber walls 9. The sealing component 7 is made of highly heat-resistant silicone plastic.

In FIGS. 1 and 2, it is further seen that a degassing opening 13 is formed in the lid 2 spanning the chambers 3, in which a degassing element 13a, for example a bursting element, is formed for each of the chambers 3 separated by intermediate walls. The degassing element opens upon reaching a specified pressure in the end-side cavity 6.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS (PART OF THE DESCRIPTION)

1 Battery module
2 Lid
3 Chamber in a battery module
4 End section of a battery module
5 Cell stack
6 End-side cavity of the chamber
7 Sealing component
8 Sealing between lid and outer chamber wall
9 Outer chamber wall, outer wall of the battery module
10 Intermediate wall between the chambers
11 End section of the intermediate wall
12 Contact flag
13 Degassing opening
13a Degassing element
20 Traction battery
21 Vehicle longitudinal direction
22 Body rocker panel
23 Vehicle width

1. A traction battery of an electrically or semi-electrically driven vehicle, comprising:
one or more cooperating battery modules, in which a plurality of chambers are provided for receiving one or more cell stacks from a respective plurality of battery cells,
wherein the battery module is configured as a hollow profile, which comprises the plurality of chambers separated from one another by intermediate walls and running parallel in a longitudinal direction of the hollow profile, into which chambers the cell stacks can be inserted,
wherein the hollow profile is sealed at both ends with a respective lid spanning end-side opening cross-sections of all chambers, and
wherein end sections of the intermediate walls reaching to the opening cross-section are sealed with a separate sealing component against an inside of the lid.

2. The traction battery according to claim 1, wherein the chambers of the hollow profile between the lid and the cell stacks include end-side cavities that are gas-tightly sealed against one another by the sealing component and outwardly by a further seal between the lid and outer chamber walls.

3. The traction battery according to claim 1, wherein the hollow profile is configured as an extrusion profile.

4. The traction battery according to claim 1, wherein the chambers separated by intermediate walls and running parallel in the longitudinal direction of the hollow profile, have identical cross-sections.

5. The traction battery according to claim 2, wherein, in the lid spanning the chambers, at least one degassing opening and/or one degassing element is formed for each of the chambers separated by intermediate walls and running parallel in the longitudinal direction of the hollow profile.

6. The traction battery according to claim 5, wherein the degassing opening or the degassing element opens upon reaching a specified pressure in one of the end-side cavities.

7. The traction battery according to claim 5, wherein a flow cross-section releasable by the degassing opening or the degassing element for degassing is larger than a gap cross-section remaining for approximately the sealing component between the end sections of the intermediate walls and an inner side of the lid.

8. The traction battery according to claim 1, wherein the sealing component is formed from an elastomeric material.

9. A battery system having the traction battery according to claim 1, wherein a plurality of individually sealed battery modules are provided, being spaced apart from one another.

10. An electrically or semi-electrically driven vehicle having the traction battery according to claim 1, wherein a plurality of battery modules positioned transversely to a vehicle longitudinal direction with their long axis are arranged one behind the other in the vehicle longitudinal direction.

11. The vehicle according to claim 10, wherein the length of the battery modules is configured such that the lid, which closes on both sides of the chambers, reaches into a region of a body rocker panel.

12. The traction battery according to claim 3, wherein the hollow profile is configured as a severed single length of a multi-length extrusion profile.

13. The traction battery according to claim 8, wherein the sealing component is formed from rubber or from a silicone plastic.
